(19) United States
(12) Patent Application Publication
(10) Pub. No.: US 2021/0055724 A1
(43) Pub. Date: Feb. 25, 2021

(54) FLEET MANAGEMENT AND FLIGHT PLANNING FOR AERIAL VEHICLES

(71) Applicant: Loon LLC, Mountain View, CA (US)

(72) Inventor: Salvatore J. Candido, Mountain View, CA (US)

(21) Appl. No.: 16/544,413

(22) Filed: Aug. 19, 2019

(51) Int. Cl. G05D 1/00; G08G 5/00

(52) U.S. Cl. CPC G05D 1/0027; G08G 5/0043; G08G 5/0039; G08G 5/0034; G08G 5/0013

(57) ABSTRACT

The technology relates to fleet management and flight planning for a fleet of aerial vehicles. For instance, a plurality of state messages may be received from the aerial vehicles. Each of the aerial vehicles may be allocated to one of a plurality of dispatcher software modules by allocating aerial vehicles according to a set of rules and after allocating aerial vehicles according to a set of rules, allocating any remaining aerial vehicles using a requesting process where one or more of the plurality of dispatcher software modules submits requests. One of the plurality of dispatcher software modules may be used to determine an intent for an aerial vehicle allocated to the one of the plurality of dispatcher software modules, wherein the intent identifies a goal location and a type of flight controller for the aerial vehicle;

### BACKGROUND

Computing devices such as personal computers, laptop computers, tablet computers, cellular phones, and countless types of Internet-capable devices are increasingly prevalent in numerous aspects of modern life. As such, the demand for data connectivity via the Internet, cellular data networks, and other such networks, is growing. However, there are many areas of the world where data connectivity is still unavailable, or if available, is unreliable and/or costly. Accordingly, additional network infrastructure is desirable.

Some systems may provide network access via a network including aerial vehicles. To maintain the network, each aerial vehicle may be required to be located at and/or to travel to a particular location. These aerial vehicles may include, for instance, drones, balloons, airships, various types of HAPs, etc. Because these aerial vehicles may be configured differently from one another or have different operating characteristics, operating according to changing operational goals, continuously moving when in flight, and may have a lifespan which would require that the aerial vehicle be removed from the fleet or otherwise taken out of service, managing a large number of such aerial vehicles can quickly become a difficult problem.

### BRIEF SUMMARY

Aspects of the present disclosure are advantageous for high aerial vehicle systems. For instance, one aspect of the disclosure provides a method of fleet management and flight planning for a fleet of aerial vehicles. The method includes receiving, by one or more processors of a dispatch system, a plurality of state messages from the aerial vehicles; and allocating, by the one or more processors, each of the aerial vehicles to one of a plurality of dispatcher software modules by: allocating aerial vehicles according to a set of rules, and after allocating aerial vehicles according to a set of rules, allocating any remaining aerial vehicles using a requesting process where one or more of the plurality of dispatcher software modules submits a request including a priority value and the any remaining aerial vehicles are allocated based on any priority values of any requests of the one or more of the plurality of dispatcher software modules. The method also includes using, by the one or more processors, one of the plurality of dispatcher software modules to determine an intent for an aerial vehicle allocated to the one of the plurality of dispatcher software modules, wherein the intent identifies a type of flight controller for the aerial vehicle; and generating, by the one or more processors, a flight plan for the aerial vehicle based on the intent.

In one example, the method also includes sending the flight plan to the aerial vehicle. In another example, the method also includes, inputting the plurality of state messages into an array, and wherein the allocating is performed periodically according to a predetermined period of time. In another example, at least one of the plurality of dispatcher software modules is configured to plan for recovery of an aerial vehicle after the aerial vehicle has landed. In another example, at least one of the plurality of dispatcher software modules is configured to plan for an aerial vehicle with a limited amount of lifetime remaining in another example, at least one of the plurality of dispatcher software modules is configured to plan for an aerial vehicle to maintain a particular location. In another example, at least one of the plurality of dispatcher software modules is configured to plan for an aerial vehicle to maintain a particular relative location. In another example, at least one of the plurality of dispatcher software modules is configured to plan for an aerial vehicle to travel to and reach a particular location. In another example, at least one of the plurality of dispatcher software modules is configured for a particular geographic region. In another example, the requesting process includes providing the plurality of state messages for the unallocated aerial vehicles to the plurality of dispatcher software modules. In another example, the requesting process includes allocating each unallocated aerial vehicle to a dispatcher software module that submitted the request for that unallocated aerial vehicle. In another example, the intent further identifies a goal location and the type of flight controller includes planning for the aerial vehicle to be recovered at the goal location. In another example, the intent further identifies a goal location and the type of flight controller includes planning for the aerial vehicle to maintain the goal location. In another example, the intent further identifies a goal location and the type of flight controller includes planning for the aerial vehicle to reach the goal location as soon as possible. In another example, the intent further identifies a goal location and the type of flight controller includes planning for the aerial vehicle to reach the goal location as a particular point in time. In another example, the intent further identifies a goal location, and the type of flight controller includes planning for the aerial vehicle to reach the goal location while avoiding other locations. In another example, the method also includes determining intents for each aerial vehicle of the plurality of aerial vehicles based on the allocations. In another example, the method also includes entering all determined intents into a queue and using the queue to generate flight plans for each of the plurality of aerial vehicles. In another example, the method also includes using, by the one or more processors, a second one of the plurality of dispatcher software modules to determine a second intent for a second aerial vehicle allocated to the second one of the plurality of dispatcher software modules, wherein the second intent identifies a type of flight controller for the second aerial vehicle; receiving an override intent for the second aerial vehicle generated by a third dispatcher software module; generating, by the one or more processors, a flight plan for the second aerial vehicle based on the override intent and disregarding the second intent. In this example, the method also includes, inputting both the second intent and the override intent into a queue, after which the flight plan for the second aerial vehicle is generated.

### BRIEF DESCRIPTION OF THE DRAWINGS

FIG. 1 is a functional diagram of a system in accordance with aspects of the present disclosure.

FIG. 2 is an example of a balloon in accordance with aspects of the present disclosure.

FIG. 3 is an example of a balloon in flight in accordance with aspects of the disclosure.

FIG. 4 is an example dispatch system in accordance with aspects of the disclosure.

FIG. 5 is an example process diagram in accordance with aspects of the disclosure.

FIG. 6 is an example process diagram in accordance with aspects of the disclosure.

FIG. 7 is an example process diagram in accordance with aspects of the disclosure.

FIG. 8 is an example flow diagram in accordance with aspects of the disclosure.

### DETAILED DESCRIPTION

### Overview

The present disclosure generally relates to fleet management and flight planning for aerial vehicles. These aerial vehicles may include, for instance, drones, balloons, airships, various types of HAPs, etc. Because these aerial vehicles may be configured differently from one another or have different operating characteristics, operating according to changing operational goals, continuously moving when in flight, and may have a lifespan which would require that the aerial vehicle be removed from the fleet or otherwise taken out of service, managing a large number of such aerial vehicles can quickly become a difficult problem. To address this, a dispatch system may be used to configure a heterogeneous mix of different and differently configured aerial vehicles in order to meet goals for various services in different places around the world. In order to do so, the dispatch system may determine on a periodic or other (e.g. ad hoc) basis how to configure the fleet based on state messages from the fleet.

The state messages may be periodically or otherwise originate as telemetry from the aerial vehicles and be augmented on the way to one or more dispatch systems with additional information. The state messages may include information such as a location of the aerial vehicle as well as its current state. The state may include information such as one or any combination of: how long the aerial vehicle has been in flight, a current mission or intent for the aerial vehicle, battery information (charge, capacity, discharge rate, etc.), etc.

The dispatch system may be ground-based computing systems that receive the state messages as a stream of data and periodically process the data. The dispatch system may include various software modules including one or more allocator software modules as well as a plurality of dispatcher software modules. The dispatcher software modules may each be used to determine an operational goal (e.g. a mission assignment) and other configuration details needed to generate a flight plan for an aerial vehicle given that aerial vehicle's state (i.e. current location, etc. as per the state messages). The dispatch system may also include a queue for intents to be enacted and a navigation software module as discussed further below.

The one or more allocator software module mays allocate each of the aerial vehicles to one of a plurality of dispatcher software modules. For instance, the allocator may be an allocator which allocates aerial vehicles to dispatchers in two phases. In the first phase, the allocator uses a rule-based approach. For any remaining unallocated aerial vehicles, the allocator may initiate a second phase including a requesting process. This may include sending the state messages for any unallocated aerial vehicles to each one of the plurality of dispatcher software modules and prompting the dispatcher software modules to submit requests for the unallocated aerial vehicles. The dispatcher software modules may then submit requests for aerial vehicles to the allocator, and a request handler software module of the allocator may allocate the remaining unallocated aerial vehicles to the dispatcher software modules submitting the requests having a highest priority.

Once aerial vehicles are allocated, each dispatcher software module may then determine an intent for any aerial vehicles assigned to that dispatcher software module. These intents may be determined according to the rules implemented at that dispatcher software module. An intent may identify a type of flight controller in order to generate a flight plan for the aerial vehicle as well as a location for the aerial vehicle. Once determined, the intents may be input into a centralized queue. This queue may be processed by a navigation software module which uses the intents to continually determine in a closed-loop fashion a series of a flight plans for each aerial vehicle. The flight plans may then be sent to each respective aerial vehicle in order to enable that aerial vehicle to proceed according to the intent.

The features described herein may allow for continuous flight planning for a fleet of aerial vehicles in a way which most effectively allocates aerial vehicles to different tasks according to the current needs of and/or requirements of the fleet. In addition, because the rules for requesting and intents are implemented at each dispatcher software module, the dispatcher software modules can be updated and/or changed without affecting the functions of other dispatcher software modules, the allocators, or the navigation module. In this regard, the dispatching system may allow a team of engineers with disparate goals and processes to develop and maintain shared control logic of a production fleet together.

### Example System

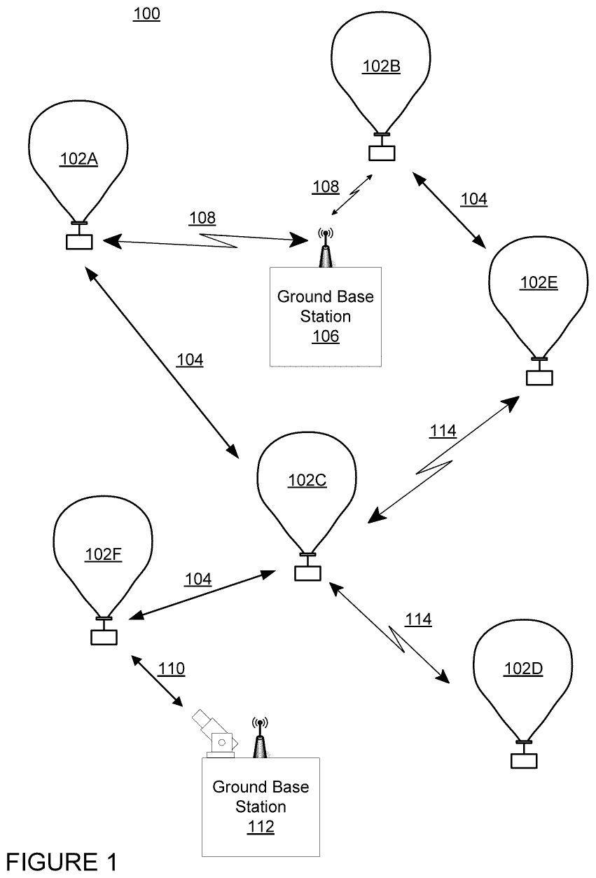

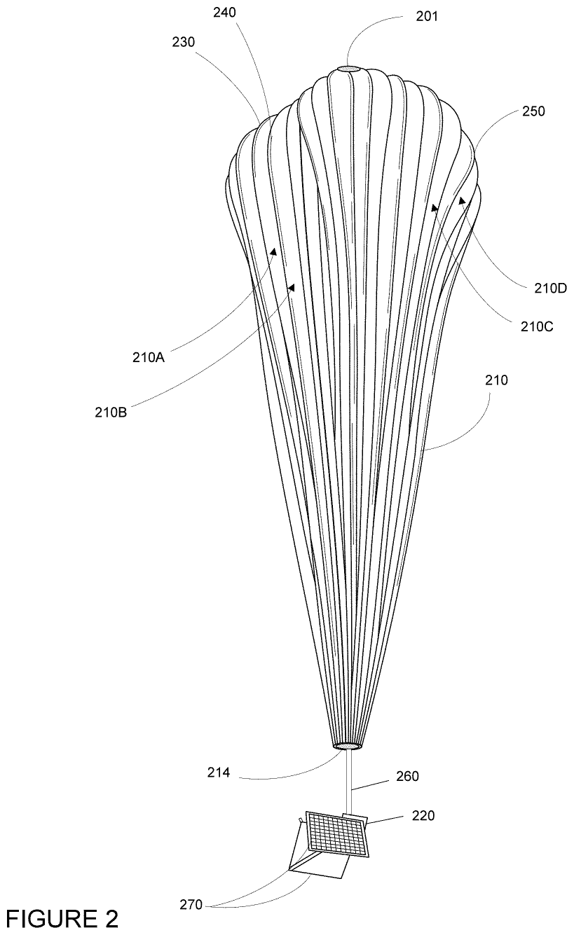

FIG. 1 depicts an example system 100 in which an aerial vehicle as described above may be used. This figure should not be considered as limiting the scope of the disclosure or usefulness of the features of the present disclosure. For example, the techniques described herein can be employed on various types of aircraft and systems. In this example, system 100 may be considered a “balloon network” though in addition to balloons the network may include other types of aircraft or aerial vehicles. As such, the system 100 includes a plurality of devices, such as balloons 102A-F, ground base stations 106 and 112 and links 104, 108, 110 and 114 that are used to facilitate intra-balloon communications as well as communications between the base stations and the balloons. One example of an aerial vehicle is discussed in greater detail below with reference to FIG. 2.

### Example Aerial Vehicle

FIG. 2 is an example balloon 200, which may represent any of the aerial vehicles of the system 100. As shown, the balloon 200 includes an envelope 210, a payload 220 and a plurality of tendons 230, 240 and 250 attached to the envelope 210. The balloon envelope 210 may take various forms. In one instance, the balloon envelope 210 may be constructed from materials such as polyethylene that do not hold much load while the balloon 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, hydrogen or any other lighter-than-air gas. The envelope 210 is thus arranged to have an associated upward buoyancy force during deployment of the payload 220.

The payload 220 of balloon 200 may be affixed to the envelope by a connection 260 such as a cable or other rigid structure. The payload 220 may include a computer system (not shown), having one or more processors and on-board data storage (similar to processors 420 and memory 430 described below). The payload 220 may also include various other types of equipment and systems (not shown) to provide a number of different functions. For example, the payload 220 may include various communication systems such as optical and/or RF, a navigation software module, a positioning system, a lighting system, an altitude control system (configured to change an altitude of the balloon), a plurality of solar panels 270 for generating power, a power supply (such as one or more batteries) to store and supply power to various components of balloon 200.

In view of the goal of making the balloon envelope 210 as lightweight as possible, it may be comprised of a plurality of envelope lobes or gores that have a thin film, such as polyethylene or polyethylene terephthalate, which is lightweight, yet has suitable strength properties for use as a balloon envelope. In this example, balloon envelope 210 is comprised of envelope gores 210A-210D.

Pressurized lift gas within the balloon envelope 210 may cause a force or load to be applied to the balloon 200. In that regard, the tendons 230, 240, 250 provide strength to the balloon 200 to carry the load created by the pressurized gas within the balloon envelope 210. In some examples, a cage of tendons (not shown) may be created using multiple tendons that are attached vertically and horizontally. Each tendon may be formed as a fiber load tape that is adhered to a respective envelope gore. Alternately, a tubular sleeve may be adhered to the respective envelopes with the tendon positioned within the tubular sleeve.

Top ends of the tendons 230, 240 and 250 may be coupled together using an apparatus, such as top cap 201 positioned at the apex of balloon envelope 210. A corresponding apparatus, e.g., bottom cap 214, may be disposed at a base or bottom of the balloon envelope 210. The top cap 201 at the apex may be the same size and shape as and bottom cap 214 at the bottom. Both caps include corresponding components for attaching the tendons 230, 240 and 250 to the balloon envelope 210.

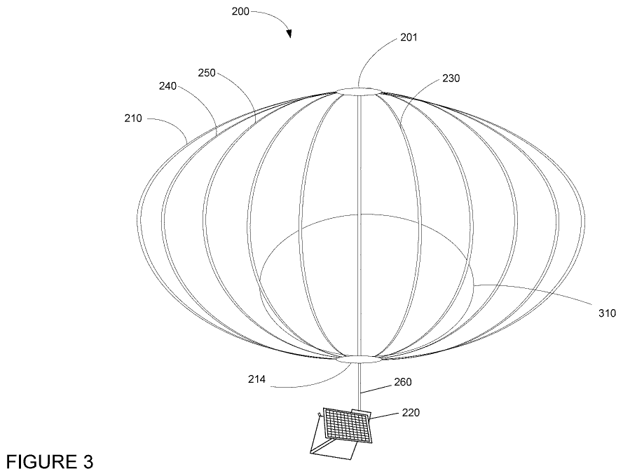

FIG. 3 is an example of balloon 200 in flight. In this example, the shapes and sizes of the balloon envelope 210, connection 260, ballast 310, and payload 220 are exaggerated for clarity and ease of understanding. During flight, these balloons may use changes in altitude to achieve navigational direction changes. For example, the altitude control system of the payload 220 may cause air to be pumped into the ballast 310 within the balloon envelope 210 which increases the mass of the balloon and causes the balloon to descend. Similarly, the altitude control system may cause air to be released from the ballast 310 (and expelled from the balloon) in order to reduce the mass of the balloon and cause the balloon to ascend.

### Example Server System

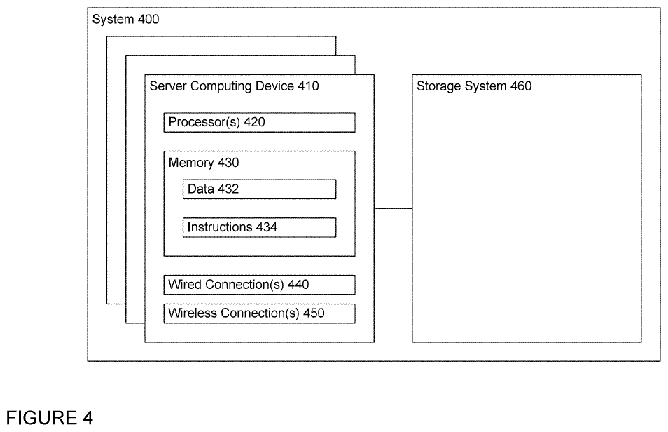

FIG. 4 is an example of a dispatch system 400 which may be, for instance, incorporated into ground base stations 106, 112. As shown, the dispatch system 400 includes one or more server computing devices 410 and a storage system 450 as shown in FIG. 4. For instance, each of ground base stations 106, 112 may be a data center including the storage system 460 as well as the server computing devices 410. In this regard, the server computing devices may function as a load balanced server farm in order to exchange information with different nodes of various networks for the purpose of receiving, processing and transmitting the data to and from other computing devices. As such, each of the one or more server computing devices 410 may include one or more processors 420, memory 430 and other components typically present in general purpose computing devices.

The memory 430 stores information accessible by the one or more processors 420, including instructions 434 and data 432 that may be executed or otherwise used by the processor 420. The memory 430 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 434 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 432 may be retrieved, stored or modified by processor 420 in accordance with the instructions 434. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processor 420 may be any conventional processors, such as commercially available CPUs or GPUs. Alternatively, the one or more processors may be a dedicated device such as an ASIC or other hardware-based processor. Although FIG. 4 functionally illustrates the processor, memory, and other elements of the server computing devices 410 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of server computing devices 410. Accordingly, references to a processor or computing device will be understood to include references to a collection of processors or computing devices or memories that may or may not operate in parallel.

The server computing devices 410 may also include one or more wired connections 440 and wireless connections 450 to facilitate communication with other devices, such as the storage system 460, one or more information services, and other devices of the system 100.

As with memory 430, storage system 460 can be of any type of computer storage capable of storing information accessible by the server computing devices 410, such as a hard-drive, memory card, ROM, RAM, DVD, CD-ROM, write-capable, and read-only memories. In addition, storage system 460 may include a distributed storage system where data is stored on a plurality of different storage devices which may be physically located at the same or different geographic locations. Storage system 460 may be connected to the server computing devices 410 directly (i.e. as part of server computing devices 410 and/or via wired connections 440) and/or via a network (i.e. via wired connections 440 and/or wireless connections 450). This network may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

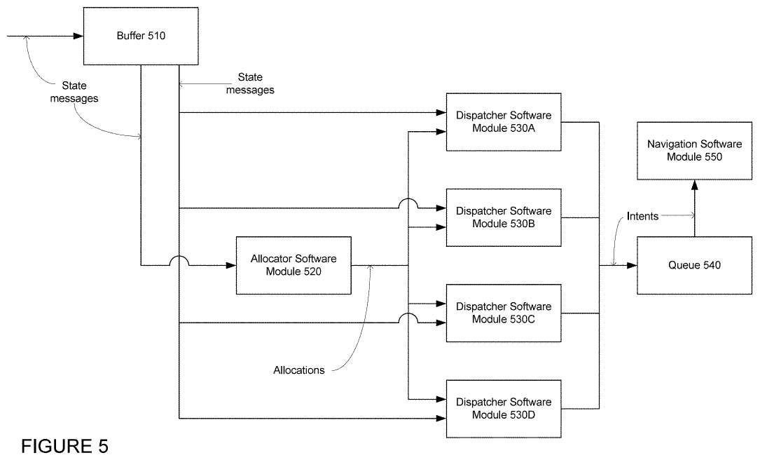

Storage system 460 and/or memory 430 may store various types of information as described in more detail below. This information may be retrieved or otherwise accessed by one or more server computing devices, such as the server computing devices 410, in order to perform some or all of the features described herein. For instance, the storage system 460 and/or memory 430 may store state information for each aerial vehicle of the fleet. This state information may include various information such as last received or current location, heading, speed, how long the aerial vehicle has been in flight, a current mission or operational goal for the aerial vehicle, a current intent for the aerial vehicle, battery information (charge, capacity, discharge rate, etc.), end of life date and/or current remaining flight time (or life expectancy) as discussed below, etc. The state information may also include information such as simulation of trajectories, automated analysis of remaining lifetime, alarms that may be alerting various conditions that may be met on the system, and various other data streams produced to allow high level decision making for a fleet of aerial vehicles. Turning to the process diagram of FIG. 5, the state messages and any other data may be stored in a buffer 510 of the storage system 460 and/or memory 430.

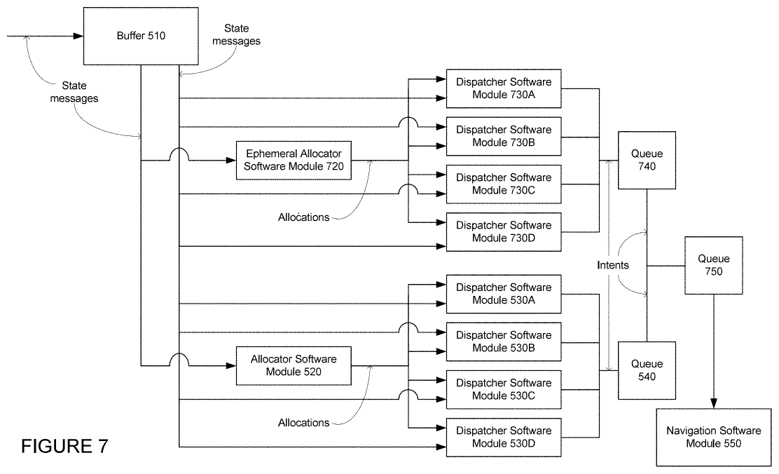

The storage system 460 and/or memory 430 may also store various software modules of the dispatch system 400. For example, the dispatch system 400 may include various software modules including one or more allocator software modules 520, 720 (shown in FIG. 7), a set of rules for the allocator software module, as well as a plurality of dispatcher software modules 530A-D. The allocator software modules 520, 570 may allocate each of the aerial vehicles to one of the plurality of dispatcher software modules as discussed further below. The dispatcher software modules 530A-D may each be configured to determine an operational goal given that aerial vehicle's current state as well as a set of rules for that dispatcher software module. For instance, the dispatcher software modules may include a recovery dispatcher software module and service dispatcher software modules each configured to determine different operational goals, for example in order to provide non-terrestrial communications network services (e.g., 4G LTE, internet of things, or fixed broadband service). Some recovery, and service dispatcher modules may be specific to different locations, such as for Peru, Nevada, Oregon, the southwestern United States, Kenya, etc. From the operational goal, the dispatcher software modules may determine an “intent” for the aerial vehicle including a type of flight controller as well as a location (e.g. a goal location) for the aerial vehicle. The intent may additionally or alternatively include or represent a desired configuration of an aerial vehicle or group of aerial vehicles, or configuration of some other service, such as other datacenter software jobs corresponding to those aerial vehicles.

For example, an alerting automation service may process telemetry data from an aerial vehicle and generate an alert or take some automated action if certain conditions are noticed, such as when an LTE system is not functioning properly. This alert may be applied to the aerial vehicle if that aerial vehicle meets certain conditions (e.g. is currently needed to provide a network as a service to a third party). In this example, certain service dispatcher software modules may configure the alerting automation service to have this configuration rule for the aerial vehicles allocated to such dispatcher software modules, but other (e.g. non-service) dispatcher software modules may configure the alerting automation service to not have that rule for the aerial vehicles allocated to such non-service dispatcher software modules. In such cases, it is not the aerial vehicle flight that is configured, but part of some other datacenter job corresponding to that aerial vehicle.

The storage system 450 and/or memory 430 may also store current goals for the system 100. This may include, for instance, the number of aerial vehicles needed for a particular operational goal and/or location. These goals may be defined at least in part at the allocator software modules and/or the dispatcher software modules. For instance, changing the set of rules of the allocator software module may change how aerial vehicles are allocated. Similarly, by changing the set of rules of the dispatcher software modules, this may change the operational goals and intents determined by the dispatcher software module.

Storage system 460 and/or memory 430 may also store one or more queues 540, 740 (shown in FIG. 7) for intents to be enacted, navigation maps which can be used to generate flight plans, and a navigation software module 550 as discussed further below. Each navigation map may be a map of wind and/or other weather data which may be used to navigate an aerial vehicle to a particular location.

### Example Methods

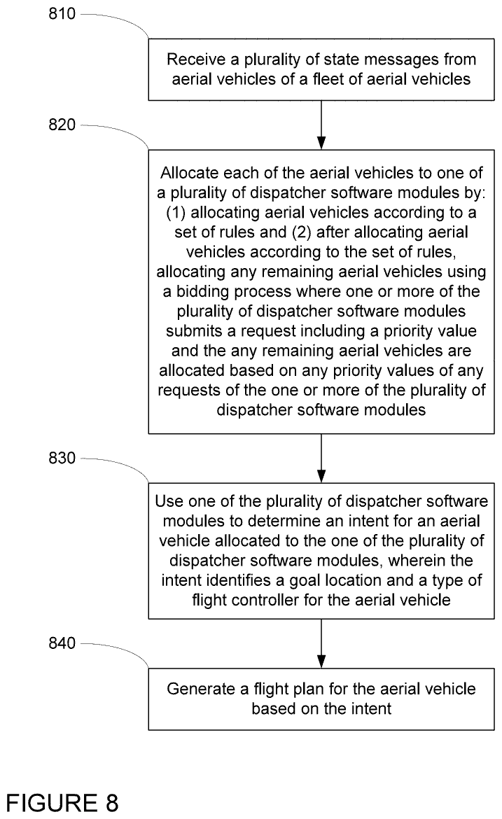

FIG. 8 is an example flow diagram 800 in accordance with aspects of the disclosure which may be performed, for instance, by the processors 420 of one or more of the server computing devices 410 of the dispatch system 400 in order to manage and flight plan for a fleet of aerial vehicles. In this example, at block 810, a plurality of state messages are received from aerial vehicles of a fleet of aerial vehicles.

The state messages may be transmitted by the aerial vehicles to the dispatch system 400. The state messages may be transmitted periodically or in any other manner, for instance on an ad hoc basis. The state messages may include information such as a location of the aerial vehicle as well as its current state. The state may include information such as one of any combination of how long the aerial vehicle has been in flight, a current mission or intent for the aerial vehicle, battery information (charge, capacity, discharge rate, etc.), etc. The state information may also include other data about the aerial vehicle's current flight such as one or any combination of launch time, flight name, operational notes, configuration of the vehicle (number of solar panels, serial number of the support structures of the aerial vehicle, etc.). The information may also or alternatively include the output of estimators and simulators that may provide stateful derived computations from telemetry such as an estimate of remaining lift gas and/or projections of what the aerial vehicle will do in the future.

In addition to the state messages, the dispatch system 400 may receive other data about the aerial vehicles. For instance, this other data may include one or any combination of simulation of trajectories, automated analysis of remaining lifetime, alarms that may be alerting various conditions that may be met on the system, and various other data streams produced to allow high level decision making for a fleet of aerial vehicles. The state messages and any other data may be stored as discussed above in a buffer such as an array. The stored information may be input into the allocator software module of the dispatch system. This may be performed on a periodic basis. For instance, returning to the process diagram of FIG. 5, state messages and other data are input into the buffer 510. Again, this buffer may be an array stored in the storage system 460 and/or the memory 430. The state messages and the other data (i.e. the state information) may be sent to or retrieved by the allocator software module 520 as well as the plurality dispatcher software modules 530A-D. This may be performed periodically, for instance every 10 to 15 minutes.

At block 820 of FIG. 8, each of the aerial vehicles are allocated to one of a plurality of dispatcher software modules by allocating aerial vehicles according to a set of rules, and after allocating aerial vehicles according to a set of rules, allocating any remaining aerial vehicles using a requesting process where one or more of the plurality of dispatcher software modules submits a request for the remaining aerial vehicles including a priority value and the any remaining aerial vehicles are allocated based on any priority values of any requests of the one or more of the plurality of dispatcher software modules. For instance, the allocator software module may allocate each of the aerial vehicles to one of a plurality of dispatcher software modules. In this regard, the allocator software module may be a rule-based allocator which allocates aerial vehicles to dispatchers in two phases.

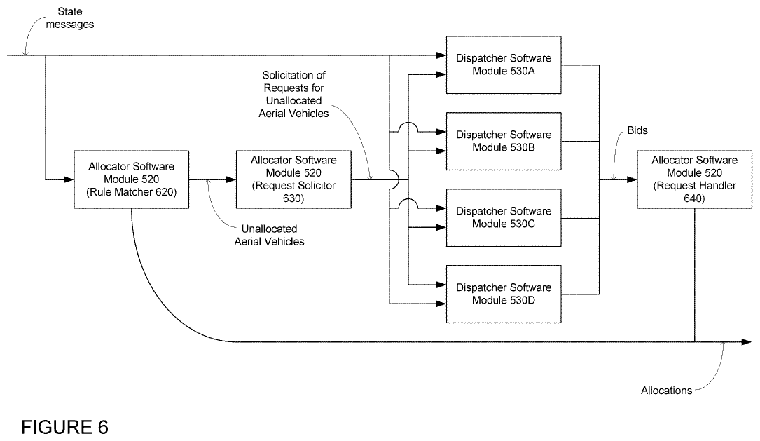

In the first phase, the allocator software module uses a rule-based approach. In other words, the allocator software module may first allocate aerial vehicles according to the set of rules for the allocator software module. For instance, turning to FIG. 6, the allocator software module 520 may receive or retrieve the state messages and other data from the buffer 510. The allocator software module 520 may then use the state messages and other data to allocate aerial vehicles of the fleet according to a set of rules. For instance, a Rule Matcher 620 of the allocator software module 520 may allocate aerial vehicles by matching the state messages and other data from the buffer with the set of rules. For example, the Rule Matcher 620 may identify any aerial vehicles, no matter their current location, that have been in flight for less than a particular duration (for instance, six hours or more or less) and allocate these aerial vehicles to a dispatcher software module that will allow them to settle (i.e. achieve some nominal operating parameters such as a certain pressurization, ballonet positioning, etc.). Thus, at some point after and aerial vehicle has settled it may be allocated to a service dispatcher software module to be sent to a particular location, etc. As another example, the Rule Matcher 630 may allocate a particular aerial vehicle to a pasture dispatcher software module or a recovery dispatcher software module based on an estimated lifetime remaining for the aerial vehicle.

For any remaining unallocated aerial vehicles, the allocator software module may initiate a second phase including a requesting process. In this regard, state messages and other data for any unallocated aerial vehicles may be sent to or retrieved by each of the plurality of dispatcher software modules 530A-D. A Request Solicitor 630 of the allocator software module may then send a message to the dispatcher software modules 530A-D requesting solicitation of requests for any unallocated aerial vehicles or rather, any aerial vehicles that were not previously allocated by the Rule Matcher 620. In this regard, the message may identify any unallocated aerial vehicles. The dispatcher software modules may then submit zero or one request per each aerial vehicle to a Request Handler 640 of the allocator software module 520. The submitted requests may include a numerical value, which in some examples may be referred to as a priority value. As an example, the priority value may be on a scale from 0 to 1, 1 representing a higher priority value than 0. Of course, the reverse or other priority value scales may also be used. The Request Handler 640 may then allocate the unallocated aerial vehicles to the dispatcher software modules by allocating aerial vehicles to the dispatcher software modules that submitted the requests with the highest priority values first. In this regard, the allocation of any unallocated aerial vehicles (i.e. those not allocated in the first phase) may be performed using a process that resembles bidding. Any allocations by the Request Handler 640 of the allocator software module 520 are then sent to the various dispatcher software modules as shown in FIG. 5.

For instance, a service dispatcher software module may submit requests with priority values determined by that service dispatcher software module based on whether the unallocated aerial vehicles have compatible hardware for the needs of that service dispatcher software module. For example, dispatcher software modules 530A and 530B may be service dispatcher software modules. Dispatcher software module 530A may require aerial vehicles to provide services in a service region where the connectivity hardware is required to broadcast LTE on Band 20 spectrum. Dispatcher software module 530B may require aerial vehicles to provide services in a Band 28 service region (or a service region that operates under Band 28 of the LTE system). As such, dispatcher software module 530A may submit a request including a priority value of 0.9 for any unallocated aerial vehicles having Band 20 filters on the LTE system, while dispatcher software module 530B may not submit any requests for unallocated aerial vehicles having Band 28 filters on the LTE system. At the same time, dispatcher software module 530B may submit a request including a priority value of 0.9 for any unallocated aerial vehicles having Band 28 filters on the LTE system, while dispatcher software module 530A may not submit any requests for unallocated aerial vehicles having Band 20 filters on the LTE system. In this example, the dispatcher software module 530A may be allocated any unallocated aerial vehicles that have Band 20 filters in order to steer them to the Band 20 service region, and the dispatcher software module 530B may be allocated any unallocated aerial vehicles that have Band 28 filters in order to steer them to the Band 28 service region.

As another instance, a service dispatcher software module may submit requests with priority values determined by that service dispatcher software module based on the location and number of aerial vehicles required by that service dispatch software module. For example, each of the dispatcher software modules 530A and 530B may be service dispatcher software modules that serve different service regions (e.g. Peru and Nevada). Both dispatcher software modules 530A and 530B may submits requests including a priority value of 0.9 for any unallocated aerial vehicles that are close (e.g. within some predetermined distance laterally) to the respective service regions of dispatcher software modules 530A and 530B. In addition, both dispatcher software modules 530A and 530B may submits requests including a priority value determined from an equation such as 1/<total number of aerial vehicles of the fleet currently in flight. for any unallocated aerial vehicles that are “new” flights (e.g. were just launched and were not previously allocated to a dispatcher software module). As a result, each of the dispatcher software modules 530A and 530B may be allocated a roughly equal number of aerial vehicles over time.

As yet another instance, a recovery dispatcher software module may submit requests with priority values determined by that recovery dispatcher software module based on aerial vehicle's expected end of life date and current remaining flight time (or life expectancy). In other words, each aerial vehicle may have a limited life or flight time during which the aerial vehicle can be reliably used to provide network services or perform other tasks. For example, dispatcher software module 530A may be a service dispatcher software module and may require aerial vehicles to provide services in a Band 20 service region (or a service region that operates under Band 20 of the LTE system). Dispatcher software module 530C may be a recovery dispatcher software module. As such, dispatcher software module 530A may submit a request including a priority value of 0.9 for any unallocated aerial vehicles having Band 20 filters on the LTE system, while dispatcher software module 530C may submit a request including a priority value of 1.0 for any unallocated aerial vehicles when the time for the aerial vehicle to reach a recovery zone (where the aerial vehicle can be retrieved after landing) plus the current remaining life expectancy of the aerial vehicle is equal to an expected end of life date for the aerial vehicle. In this regard, the dispatcher software module 530C may not submit any requests for aerial vehicles that do not meet this condition. As a result, aerial vehicles may be used for providing service until the aerial vehicles needs to be flown towards the recovery zone for recovery.

Code for making requests may be implemented in the plurality of dispatcher software modules and not at the allocator software module. This allows engineers or other system administrators to implement rather complex reasoning about how to assign flights at each dispatcher software module (in the form of the requesting code) without requiring operators to understand a global optimization at the allocator level encompassing every aspect and consideration present across all of the plurality of dispatcher software modules. In this regard, each dispatcher software module may submit requests based on rules implemented at that dispatcher software module. These rules may define the current needs and/or requirements for the fleet, and can be updated at the dispatcher software modules by engineers as needed. For example, if five aerial vehicles have been allocated to a service dispatcher software module for the airspace over the geographic area of Peru, but current rules for the service dispatcher software module indicate that six aerial vehicles need to be sent to airspace over Peru, that dispatcher software module may submit a request having a higher priority value for aerial vehicles which are close to or within airspace over Peru. As another example, a recovery dispatcher software module may submit a request having a higher priority for aerial vehicles that have only a certain period of time left in an expected lifetime for the aerial vehicle. In some instances, in order to ensure that more aerial vehicles are allocated to a specific dispatcher software module, the code and/or configuration at the allocator software modules may be changed. For instance, the allocator rules may be changed in order to allocate all aerial vehicles with certain characteristics to a specific dispatcher software module.

Returning to FIG. 8, at block 830, one of the plurality of dispatcher software modules is used to determine an intent for an aerial vehicle allocated to the one of the plurality of dispatcher software modules. The intent identifies a desired operational configuration, such as, a goal location and a flight controller, for the aerial vehicle. As such, each dispatcher software module may then determine an “intent” for any aerial vehicles assigned to that dispatcher software module. These intents may be determined according to the aforementioned rules implemented at that dispatcher software module. As noted above, an intent may identify a type of flight controller as well as a location (e.g. a goal location) for the aerial vehicle, and may include or represent a desired configuration of an aerial vehicle or group of aerial vehicles, or configuration of some other service. In order to determine an intent, the dispatcher software modules may first identify an operational goal for each aerial vehicle. These operational goals may be already known to each dispatcher software module or rather, encoded into the dispatcher software module. For instance, a recovery dispatcher software module may have an operational goal for recovery of an aerial vehicle. A service dispatcher software module may have an operational goal for (and be configured to plan for) maintaining a particular location or relative location of the aerial vehicle and/or for an aerial vehicle to reach a particular location or area. For example, the service dispatcher software modules may have an operational goal including, for instance, providing mobile network service in a particular location, providing fixed broadband access to particular endpoints, maintaining vehicles in a position to respond to a telecommunications outage, etc. As one example, the geographic area and the population to which Internet services are to be provided may be known. A few different sets of goal locations may be identified and simulations run to optimize where the exact placement of the aerial vehicles should be in order to provide those services. Whatever placement is chosen may be encoded into a dispatcher software module. Alternatively, the dispatcher software modules may receive the geographic area and population details and optimize the goal locations for themselves.

Once an operational goal is determined, each dispatcher software module may be configured to use its rules to select or determine the flight controller and goal location for an aerial vehicle to achieve that operational goal. The type of flight controller may be identified based on the operational goal for the aerial vehicle and/or the type of dispatcher software module. In this regard, an intent may include instructions for making sure a certain type of flight controller is used when generating a flight plan for the aerial vehicle, that no flight controller is used, or for not changing whatever flight controller is currently being used. The intent may also identify the goal location as well as other information such as a desired arrival time at the goal location, state, a particular navigation map (which may be used to generate a flight plan to particular region, to avoid a particular no-fly region where the aerial vehicle should not fly through or over, and/or at a desired arrival time), or any other information in order to enable the operational goal of the dispatcher software module.

One flight controller, a recovery flight controller may plan for an aerial vehicle to be recovered at a certain location (after the aerial vehicle has landed). In this regard, the recovery dispatcher software module may identify the recovery flight controller. Another flight controller, a station keeping flight controller, may plan for an aerial vehicle to maintain a location. Yet another type of flight controller, a station seeking flight controller, may plan for an aerial vehicle to reach a certain location as soon as possible. In addition, or alternatively, another station seeking flight controller may plan for an aerial vehicle to reach a certain location at a particular date and/or time, for instance in order to provide specific network services or enable pasture (i.e. end of life for the aerial vehicle) behaviors. In addition, or alternatively, another station seeking flight controller may plan for an aerial vehicle to reach a certain location while avoiding other locations. In this regard, the service dispatcher software module may identify one of the stations keeping flight controller or the various station seeking flight controllers.

The goal location, and in some cases also an arrival time or other information included in the intent, may be used to identify which navigation map to use. For instance, each different navigation map may be built to bring an aerial vehicle to a specific region. New navigation maps may be generated as the navigation system software module or another software module receives new weather data. In this regard, the goal location may be used to identify a navigation map. The time horizon may identify how far into the future the navigation map should be processed. For example, the recovery dispatcher software module may be configured to use its rules to determine configuration details needed for an aerial vehicle that should land in a convenient location for retrieval or at some other location. For another example, the station seeking and/or station keeping dispatcher software module may be configured to use its rules to determine configuration details for an aerial vehicle to remain within a bounded region that is well-suited to longevity testing of the aerial vehicle's hardware. For another example, the station seeking and/or station keeping dispatcher software module may use its rules to determine configuration details for maintaining a particular location or relative location of the aerial vehicle and/or for an aerial vehicle to reach a particular location or area.

Returning to FIG. 8, at block 840, a flight plan for the aerial vehicle is generated based on the intent. For instance, the intents may be input into the queue 540 as shown in FIG. 5. This queue may be processed by the navigation software module which uses the intents (including the type of flight controller, configuration details, and the goal location) to continually determine in a closed-loop fashion a series of a flight plans for each aerial vehicle. For example, the navigation software module may determine new or updated flight plans for an aerial vehicle each time new state messages are received by the navigation software module from the aerial vehicles. The flight plan may be a series of altitude and/or heading changes which the aerial vehicle can use in order to achieve the intent. The flight plan may be determined, for instance, using the navigation map identified in the configuration details and path planning through the map according to the flight controller and the configuration details (i.e. which map and for what time horizon). The flight plans may then be sent via the network 100 to each respective aerial vehicle in order to enable that aerial vehicle to proceed according to the intent. The flight plan may then be transmitted to the aerial vehicle, which may be controlled in accordance with the flight plan.

In some instances, such as is depicted in the process diagram of FIG. 7, the dispatch system may also include an ephemeral allocator software module 720 which can temporarily override intents determined by the dispatcher software modules 530A-530B. Generally, these overrides may be intended to be short-term (e.g. lasting only a few minutes to a few hours). In order to do so, the ephemeral allocator software modules 720 may allocate via a set of rules to a second set of dispatcher software modules 730A-730D. This set of rules, for instance, may be established by engineers or operators to have specific aerial vehicles assigned to specific ones of the dispatcher software modules 730A-730D. In some instances, a requesting process, corresponding to that described above, may also be used by the ephemeral allocator software module to allocate aerial vehicles to specific ones of the dispatcher software modules 730A-730D.

Like dispatcher software modules 530A-530B, dispatcher software modules 730A-730D may determine intents for any allocated aerial vehicles according to sets of rules for each of the dispatcher software modules 730A-730D. Again, these sets of rules may be established engineers or operators to determine specific intents for any allocated aerial vehicles. Thus, the ephemeral allocator software module may enable engineers or other operators to set their own ephemeral intents, or rather, to requisition aerial vehicles for short term experimental use or safety reasons without affecting the allocation or intent determining process. In addition, by incorporating corresponding rules into the ephemeral allocator software module 720, the ephemeral allocator software module may enable engineers or operators to effect some types of intents automatically, such as dangerous weather avoidance, zero pressure avoidance (e.g. for an aerial vehicle with an envelope avoiding a drop to zero pressure within the envelope), and risk of flying into a restricted region. In other words, aerial vehicles which are likely to encounter such situations (e.g. dangerous weather, zero pressure, flying into a restricted region, etc.) may be automatically allocated to specific dispatcher software modules (here, one or more of dispatcher software modules 730A-730D) that are configured with rules to address such situations. For instance, if six aerial vehicles are to travel to airspace over Nevada, and one aerial vehicle is needed for an experiment, for instance, to capture weather or other data, removing this one aerial vehicle would affect the allocation and intents for the entire system and may cause the dispatch system to reconfigure the aerial vehicles in unnecessary, time consuming ways. However, by using the ephemeral allocator, that one aerial vehicle may be allocated by the ephemeral allocator to a dispatcher software module that determines an intent for that one aerial vehicle in order to enable the experiment as long as needed. At the same time, the aerial vehicle would also be allocated by the allocator software module 520 and assigned to one of the dispatcher software modules 530A-530D which will determine an intent. Again, as noted above, this intent may be discarded. As such, the dispatch system may be able to maintain the “status quo” even if an aerial vehicle is taken away from its determined intent for a short period.

Each ephemeral intent may be entered in the queue 740 specifically designated for ephemeral intents different from the queue 540. In order to ensure that the ephemeral intents override or are enacted before other intents, the navigation software module 550 may process the intents from the queue 740 before the queue 540, for instance, by generating a combined set as queue 750 where ephemeral intents (from queue 740) come before other intents (from queue 540). In addition, when ephemeral intents are enacted, any other intents for the same aerial vehicles in the queue 750 may be discarded. When the navigation software module receives from queue 750 an ephemeral intent (originally from queue 740) and another intent (originally from queue 540) for the same aerial vehicle, the ephemeral intent may be given precedence and the other intent (originally from queue 540) may be disregarded.

For instance, if six aerial vehicles are to travel to airspace over Nevada, and one aerial vehicle is needed for an experiment, for instance, to capture weather or other data, removing this one aerial vehicle would affect the allocation and intents for the entire system and may cause the dispatch system to reconfigure the aerial vehicles in unnecessary, time consuming ways. However, by using the ephemeral allocator, that one aerial vehicle may be allocated by the ephemeral allocator to a dispatcher software module that determines a first intent for that one aerial vehicle in order to enable the experiment as long as needed. At the same time, that same aerial vehicle would also be allocated by the allocator software module 520 and allocate the aerial vehicle to one of the dispatcher software modules 530A-530D. That dispatcher software module may then determine a second intent for the aerial vehicle. This second intent would be entered into queue 540 and eventually queue 750. Again, as noted above, only the first intent would be processed by the navigation software modules 550, and the second intent may be discarded. As such, the dispatch system may be able to maintain the “status quo”, essentially pretending that an aerial vehicle is operating according to the second intent for the purposes of managing the fleet of aerial vehicles, even when that aerial vehicle is taken away from that second intent for a short period.

In order to ensure highly reliable continuity in fleet operations, multiple redundant dispatch systems may be run independently of one another. For instance, two or more identical dispatch systems may be running in two or more different data centers. A master election may be used to determine which dispatch system enacts its queue of intents, and is therefore a de facto control system to be used to generate flight plans. If the elected dispatch system (for instance, dispatch system 400) fails to generate new intents in the queue 540 (and or/queue 740), another of the dispatch systems may be elected immediately. However, if the different dispatch systems do not share a common state, and may run different software modules, there may be some lack of consistency or continuity if the mater election is changed.

As an alternative or in addition to the two-phased allocation process described above, different allocation processes and steps may also be used to allocate aerial vehicles to dispatcher software modules. For instance, a massive global optimization, a deep neural network, a pure random choice approach, and/or a query to human operators may be employed.

The features described herein may allow for continuous flight planning for a fleet of aerial vehicles in a way which most effectively allocates aerial vehicles to different tasks according to the current needs of and/or requirements of the fleet. In addition, because the rules for requesting and intents are implemented at each dispatcher software module, the dispatcher software modules can be updated and/or changed without affecting the functions of other dispatcher software modules, the allocator software modules, or the navigation software module. In this regard, the dispatching system may allow a team of engineers with disparate goals and processes to develop and maintain shared control logic of a production fleet together.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of fleet management and flight planning for a fleet of aerial vehicles, the method comprising:
receiving, by one or more processors of a dispatch system, a plurality of state messages from the aerial vehicles;
allocating, by the one or more processors, each of the aerial vehicles to one of a plurality of dispatcher software modules by:
allocating aerial vehicles according to a set of rules, and
after allocating aerial vehicles according to a set of rules, allocating any remaining aerial vehicles using a requesting process where one or more of the plurality of dispatcher software modules submits a request including a priority value and the any remaining aerial vehicles are allocated based on any priority values of any requests of the one or more of the plurality of dispatcher software modules;
using, by the one or more processors, one of the plurality of dispatcher software modules to determine an intent for an aerial vehicle allocated to the one of the plurality of dispatcher software modules, wherein the intent identifies a type of flight controller for the aerial vehicle; and
generating, by the one or more processors, a flight plan for the aerial vehicle based on the intent.

2. The method of claim 1, further comprising, sending the flight plan to the aerial vehicle.

3. The method of claim 1, further comprising, inputting the plurality of state messages into an array, and wherein the allocating is performed periodically according to a predetermined period of time.

4. The method of claim 1, wherein at least one of the plurality of dispatcher software modules is configured to plan for recovery of an aerial vehicle after the aerial vehicle has landed.

5. The method of claim 1, wherein at least one of the plurality of dispatcher software modules is configured to plan for an aerial vehicle with a limited amount of lifetime remaining.

6. The method of claim 1, wherein at least one of the plurality of dispatcher software modules is configured to plan for an aerial vehicle to maintain a particular location.

7. The method of claim 1, wherein at least one of the plurality of dispatcher software modules is configured to plan for an aerial vehicle to maintain a particular relative location.

8. The method of claim 1, wherein at least one of the plurality of dispatcher software modules is configured to plan for an aerial vehicle to travel to and reach a particular location.

9. The method of claim 1, wherein at least one of the plurality of dispatcher software modules is configured for a particular geographic region.

10. The method of claim 1, wherein the requesting process includes providing the plurality of state messages for the unallocated aerial vehicles to the plurality of dispatcher software modules.

11. The method of claim 1, wherein the requesting process includes allocating each unallocated aerial vehicle to a dispatcher software module that submitted the request for that unallocated aerial vehicle.

12. The method of claim 1, wherein the intent further identifies a goal location and the type of flight controller includes planning for the aerial vehicle to be recovered at the goal location.

13. The method of claim 1, wherein the intent further identifies a goal location and the type of flight controller includes planning for the aerial vehicle to maintain the goal location.

14. The method of claim 1, wherein the intent further identifies a goal location and the type of flight controller includes planning for the aerial vehicle to reach the goal location as soon as possible.

15. The method of claim 1, wherein the intent further identifies a goal location and the type of flight controller includes planning for the aerial vehicle to reach the goal location as a particular point in time.

16. The method of claim 1, wherein the intent further identifies a goal location, and the type of flight controller includes planning for the aerial vehicle to reach the goal location while avoiding other locations.

17. The method of claim 1, further comprising, determining intents for each aerial vehicle of the plurality of aerial vehicles based on the allocations.

18. The method of claim 17, further comprising:
entering all determined intents into a queue; and
using the queue to generate flight plans for each of the plurality of aerial vehicles.

19. The method of claim 18, further comprising:
using, by the one or more processors, a second one of the plurality of dispatcher software modules to determine a second intent for a second aerial vehicle allocated to the second one of the plurality of dispatcher software modules, wherein the second intent identifies a type of flight controller for the second aerial vehicle;
receiving an override intent for the second aerial vehicle generated by a third dispatcher software module;
generating, by the one or more processors, a flight plan for the second aerial vehicle based on the override intent and disregarding the second intent.

20. The method of claim 19, further comprising, inputting both the second intent and the override intent into a queue, after which the flight plan for the second aerial vehicle is generated.
